(19) United States
(12) Patent Application Publication
(10) Pub. No.: US 2025/0298548 A1
(43) Pub. Date: Sep. 25, 2025

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: TOMOKI SHIBAMORI, Kanagawa (JP)

(21) Appl. No.: 19/085,730

(22) Filed: Mar. 20, 2025

(30) Foreign Application Priority Data
Mar. 21, 2024 (JP) 2024-044642

(51) Int. Cl. G06F 3/12

(52) U.S. Cl. CPC G06F 3/1204; G06F 3/1253; G06F 3/1255; G06F 3/1275

(57) ABSTRACT

A method of controlling an information processing apparatus including a first application program includes executing a first process of causing the first application program to display a screen for executing printing in a case where an extension of data selected on a selection screen is an extension which an OS is notified of and which is compatible with a print function of the first application program, and executing a second process of launching a second application program in a case where the extension of the data selected on the selection screen is an extension which the OS is notified of and which is incompatible with the print function, the second application program being different from the first application program and supporting the extension of the data selected on the selection screen.

### BACKGROUND OF THE INVENTION

### Field of the Invention

The present disclosure relates to an information processing apparatus, a method of controlling an information processing apparatus, and a storage medium.

### Description of the Related Art

Heretofore, a portal application has been known which runs on an information processing apparatus and which is capable of outputting a print command to an image processing apparatus such as a printer. The portal application is capable of receiving input of document data or image data stored in an information processing apparatus such as a personal computer (PC), and preforming print preview and print processes of the received data. There are various data formats of print target data. For example, in the case of document data, there are formats such as the PDF format and the DOCX format used in Microsoft Word (registered trademark) or the like. In the case of image data, there are formats such as the Jpeg format and the png format.

In order for the portal application to perform the preview and print processes of the received data, the portal application needs to internally perform a process of interpreting a data structure (rendering process). In the case of a general portal application, before a file selection is received, a process of excluding (filtering off) files with data structures that cannot be interpreted by the portal application is performed in order to disable such files from being selected. Thus, a file section screen is configured to disable users from selecting any file with a data structure that cannot be interpreted by the portal application.

Japanese Patent Laid-Open No. 2005-49929 (hereinafter referred to as Document 1) discloses a technique relating to file extensions and applications. Document 1 discloses the technique of associating not only the file extensions with the applications, but also directories with the applications, thereby making it possible to change an application to be launched for each directory.

There has been a demand for further improvement of convenience of applications.

### SUMMARY OF THE INVENTION

A method of controlling an information processing apparatus including a first application program according to one aspect of the present disclosure includes: notifying an operating system (OS) in the information processing apparatus of one or more extensions; executing control to display a selection screen for selecting data; and in a case where an extension of data selected on the selection screen is contained in the one or more extensions which the OS is notified of and is contained in one or more extensions compatible with a print function equipped in the first application program, executing a first process of causing the first application program to display a screen for executing printing based on the data selected on the selection screen, and in a case where the extension of the data selected on the selection screen is contained in the one or more extensions which the OS is notified of but is not contained in the one or more extensions compatible with the print function, executing a second process of launching a second application program which is different from the first application program and which supports the extension of the data selected on the selection screen.

Further features of the present invention will become apparent from the following description of exemplary embodiments with reference to the attached drawings.

### BRIEF DESCRIPTION OF THE DRAWINGS

FIG. 1 is a block diagram illustrating an example of a hardware configuration of an information processing apparatus;

FIG. 2 is a diagram illustrating an example of a system configuration;

FIG. 3 is a diagram for explaining file extension association data;

FIG. 4 is a diagram illustrating an example of a startup screen of a portal application;

FIG. 5 is a flowchart presenting an example of a sequence of processing in a photo print function;

FIG. 6 is a diagram presenting a list of extensions to be displayed on a file selection screen;

FIG. 7 is a diagram illustrating an example of the file selection screen;

FIG. 8 is a diagram illustrating an example of a print setting screen;

FIG. 9 is a flowchart presenting an example of a sequence of processing in a document print function;

FIG. 10 is a diagram presenting a list of extensions to be displayed on a file selection screen;

FIG. 11 is a diagram illustrating an example of the file selection screen;

FIG. 12 is a diagram presenting a list which stores extensions and information as to whether or not each extension is processable in an application; and

FIGS. 13A and 13B are diagrams illustrating an example of messages displayed by a portal application.

### DESCRIPTION OF THE EMBODIMENTS

Hereinafter, embodiments of the present disclosure will be described in detail in reference to the attached drawings. The following embodiments are not intended to limit the matters disclosed herein. In addition, all the combinations of features described in the following embodiments are not necessarily essential for the solution of the present disclosure. The same constituent elements will be designated below with the same reference sign.

### First Embodiment

### Overview

Hereinafter, an overview of the present embodiment will be described. In the present embodiment, an application program will be abbreviated as an app or an application. As described above, in order for a portal app to perform the preview and print processes of received data, the portal app needs to internally perform the process of interpreting a data structure (rendering process). In the case of a general portal app, before a file selection is received, a process of excluding (filtering off) files with data structures that cannot be interpreted by the portal app is performed in order to disable such files from being selected. In other words, the general portal app is configured to disable users from selecting any file with a data format unprocessable in the portal app. A data format unprocessable in the portal app will be also referred to as a data format incompatible with the portal app in some cases.

In the case where the above filtering is performed, it is difficult for a user to understand that a file that is not selectable on a file selection screen of the portal app is in a data format incompatible with the portal app. In addition, in a case where the user desires to print a file in a data format incompatible with the portal app, there is no way to open the file on the portal app. For this reason, the user must leave the portal app, and perform operations of opening a folder in which the file is stored using an additionally launched filer, which is one of the functions of the operating system (OS) or the like, and then selecting the file. The filer is a type of application to manage files and folders. In a case where the filer receives an operation of selecting a file, the OS launches an application associated with the file, so that the file is opened. In this way, the user has to open the file by using the application different from the portal app and further make an instruction to print the file via the different application. For this reason, the user has to switch the application to be launched according to the data format of the file that the user desires to print, resulting in a decrease in usability.

As described above, the portal app performs the file filtering by using, for example, a filer function in the OS. Specifically, the portal app opens a file list by using the filer function in the OS. In this process, the portal app notifies the filer function in the OS of information on the data format (for example, the extension) of a file to be opened, so that the filtering is performed.

In an embodiment to be described below, a user is enabled to select, on a portal app, a file in a data format incompatible with the portal app (hereinafter also referred to as an incompatible file). In a case where the user selects an incompatible file, the user is notified that the file is in a file format unprocessable in the portal app. This makes it possible for the user to easily understand that the file selected by him/her is an incompatible file unprocessable in the portal app. In the embodiment to be described below, an example will be described in which the user is enabled to launch an external application associated with an incompatible file by performing an operation via the portal app. This enables even an incompatible file unprocessable in the portal app to be seamlessly printed via the external application launched through the portal app. Accordingly, for even an incompatible file, a series of processing for printing can be started from the portal app in the same way as for files processable in the portal app. In this way, routes leading to printing are unified into one route, improving user's convenience.

### Hardware Configuration of Information Processing Apparatus

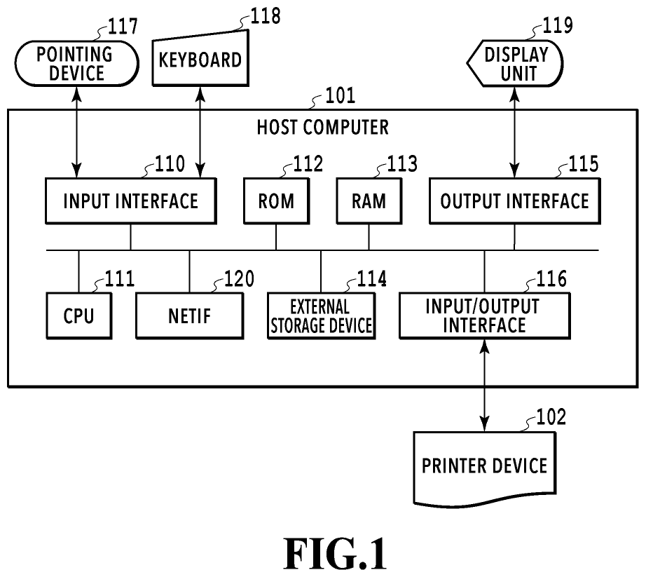

FIG. 1 is a block diagram illustrating an example of a hardware configuration of an information processing apparatus. In FIG. 1, a host computer 101 is an example of the information processing apparatus. As illustrated in FIG. 1, the host computer 101 includes an input interface 110, a CPU 111, a ROM 112, a RAM 113, an external storage device 114, an output interface 115, an input/output interface 116, and a NETIF 120. Input devices such as a keyboard 118 and a pointing device 117 are connected to the input interface 110. The input interface 110 is a reception unit to receive various instructions from a user. A display device such as a display unit 119 is connected to the output interface 115. The NETIF 120 is a network interface and performs control for data transfer from and to external apparatuses via a network.

The ROM 112 stores an initialization program. The external storage device 114 stores application programs, an operating system (OS), a driver of a printer device (printer driver), and other various kinds of data. The RAM 113 is used as a work memory for executing the various programs stored in the external storage device 114 or for other purposes.

In the present embodiment, the CPU 111 performs processes in accordance with procedures in the programs stored in the ROM 112, thereby implementing the following functions and processing according to the following flowcharts in the host computer 101. A printer device 102 is connected to the host computer 101 via the input/output interface 116.

In the present embodiment, the host computer 101 is described as an example of the information processing apparatus, but the information processing apparatus is not limited to such configuration. For example, the information processing apparatus may be a smartphone or tablet.

### System Configuration of Information Processing Apparatus

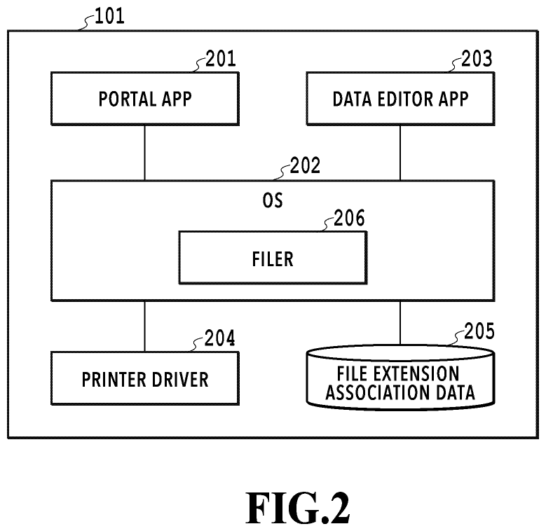

FIG. 2 is a diagram illustrating an example of a system configuration of the information processing apparatus in the present embodiment. As illustrated in FIG. 2, in the present embodiment, an OS 202, and a portal app 201 and a data editor app 203, which run on the OS 202, and device drivers such as a printer driver 204 are installed in the host computer 101. In addition, a part of data to be used by the OS 202 is file extension association data 205. In the present specification, a program to execute an application will be also referred to as an application or an app in some cases. The apps, the OS, and the data illustrated in FIG. 2 are stored in the ROM 112, the external storage device 114, or the like.

The present embodiment will be described by taking an example using the host computer 101 equipped with Windows (registered trademark) OS of Microsoft (registered trademark).

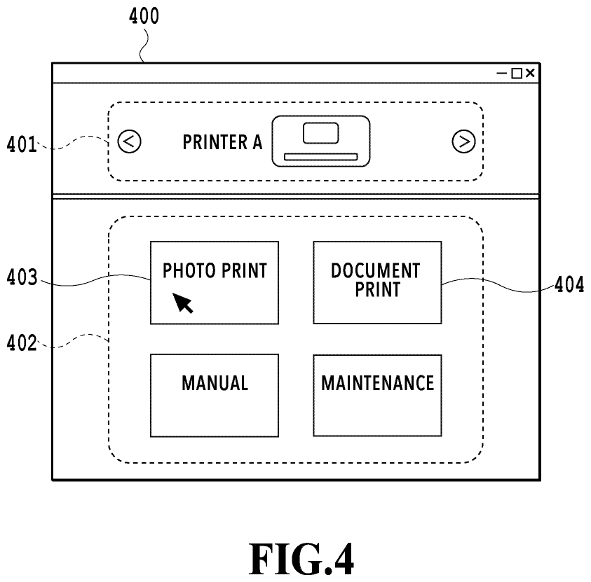

The portal app 201 is a portal app to provide various functions related to the printer device 102. The various functions include a print function compatible with the printer driver 204 installed in the OS 202. The various functions may include various functions other than the print function, such as a scanning function that executes a scan on the printer device, and a maintenance function that performs maintenance on the printer device, but the present embodiment will be described with a focus on the print function. After the portal app 201 is launched, the portal app 201 displays a main screen (see FIG. 4, which will be described later in detail) presenting a list of various functions on the display unit 119. In a case where the user selects an item (for example, a button icon) associated with a function on the main screen, a process associated with the selected function is performed.

In a case where the user selects the print function on the portal app 201, the portal app 201 displays a print data selection screen on the display unit 119. In a case where the user selects source data that the user desires to print on the print data selection screen, the portal app 201 displays a print setting screen to be used for the selected source data. The user is enabled to make basic print settings and a print start instruction on the print setting screen. In response to reception of a print start instruction from the user, the portal app 201 generates print data based on the source data selected by the user and the print settings. The portal app 201 outputs a print command so that the printer device 102 will print the generated print data by using the printer driver 204. In response to the print command, the printer device 102 performs printing using the print data.

The data editor app 203 has a function to create and edit data in a specific data format. The data editor app 203 is capable of outputting the created data as a file to the external storage device 114 or the like. An example of the data editor app 203 is a text editor. The text editor has a function to create and edit text data and is capable of outputting the created text to the external storage device 114 in a file format with an extension name “.txt”, for example.

The printer driver 204 is software for controlling the printer device 102. For example, the printer driver 204 converts the print data into a data format that can be interpreted by the printer device 102 and receives information indicating a state of the printer device 102 from the printer device 102.

The file extension association data 205 is data in which associations of extensions of files (also called file extensions) with applications are stored, and is the data to be used by a filer 206 in the OS 202 or others.

The filer 206 is a program to control a filer function equipped as standard in the OS 202. The filer 206 is capable of identifying an application associated with a file extension in reference to the information in the file extension association data 205. The filer 206 operates as a standalone application in some cases, or operates by being referenced to by another application (for example, the portal app 201) in other some cases. First, an example in which the filer 206 operates as a standalone application will be described.

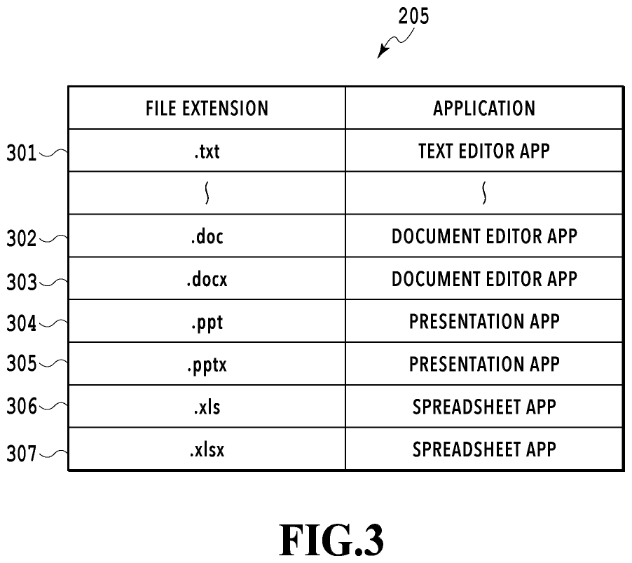

FIG. 3 is a diagram presenting a table for explaining data stored in the file extension association data 205. The table in FIG. 3 stores information on file extensions and applications associated with these file extensions. For example, an item 301 indicates that an extension “.txt” is associated with a text editor app. In the process of installing the data editor app 203, an item may be added to or change in the file extension association data 205. The user is also allowed to operate to change an application to be associated with any file extension in the file extension association data 205 from a graphical user interface (GUI) for making settings in the OS 202.

The filer 206 is capable of identifying an application associated with a file extension in reference to the information in the file extension association data 205. In a case where the filer 206 receives a file selection by the user, the filer 206 transmits an instruction to the OS 202 to launch the identified application and open the selected file. In response to this instruction, the OS 202 launches the associated application and the launched application opens the file selected by the user. In this way, the OS 202 (and the filer 206) is capable of launching the application associated with each extension in reference to the file extension association data 205. Although the example in which the filer 206 transmits an instruction to launch an identified application to the OS 202 is described herein, the OS 202 may identify the application. Specifically, the filer 206 may transmit information on the selected file to the OS 202, and the OS 202 may identify the application associated with the extension in reference to the file extension association data 205 and launch the identified application.

For example, in a case where the user desires to open a file with the “.txt” extension, the user launches the filer 206 and inputs an instruction to open the file desired to be opened. Upon receipt of the instruction to open the file, the OS 202 refers to the item 301 in the file extension association data 205 and obtains the information on the text editor app associated with the “.txt” extension. The OS 202 launches the text editor app based on the obtained information on the text data app and makes an instruction to open the file to the launched text editor app. As a result of this series of processing, the user can cause the text editor app to be launched and open the file with the “.txt” extension, for which the user makes the open instruction on the filer 206. This mechanism of the OS 202 allows the user to open files with appropriate applications associated with various file extensions, without having to select and launch an application associated with each of the file extensions.

An item 302 indicates that a “.doc” extension is associated with a document editor app, and is referenced by the OS 202 in a case where the OS 202 receives an instruction to open a file with the “.doc” extension. In a case where the user makes an instruction to open a file with the “.doc” extension by using the filer 206, the OS 202 refers to the item 302 and opens the file with the “.doc” extension by using the document editor app. Similarly, an item 303 indicates that a “.docx” extension is associated with the document editor app. Items 304 and 305 indicate that “.ppt” and “.pptx” extensions are associated with a presentation app. Items 306 and 307 indicate that “.xls” and “.xlsx” extensions are associated with a spreadsheet application. The associations presented in FIG. 3 are just an example, and associations are not limited to this example.

An example in which the filer 206 is referenced to by an external application (for example, the portal app 201) will be described in the following section titled “Operation Overview of Portal App”.

### Operation Overview of Portal App

FIG. 4 is a diagram illustrating an example of a startup screen of the portal app 201. Hereinafter, an operation overview of the portal app 201 will be described in reference to FIG. 4. Once the portal app 201 is launched, the portal app 201 displays a screen 400 on the display unit 119. The screen 400 contains a printer information area 401 and a function button area 402. In the printer information area 401, a printer name and a printer image icon of the printer device 102 set as a target printer are displayed. In the function button area 402, buttons of functions executable on the target printer device 102 are displayed. A photo print function button 403 is one of the buttons displayed in the function button area 402, and is the function button to instruct the portal app 201 to cause the target printer device 102 to print photo data via the printer driver 204. A document print function button 404 is a function button to instruct the portal app 201 to cause the target printer device 102 to print document data via the printer driver 204. The portal app 201 is configured to receive a selection of photo data in the photo print function and receive a selection of document data in the document print function.

Upon receipt of an instruction made by the user pressing down the photo print function button 403, the portal app 201 starts executing the photo print function. Hereinafter, first, an operation overview of a general portal app 201 will be described by using execution of the photo print function as an example. After that, an operation overview of the portal app 201 with improved convenience will be described by using execution of the document print function as an example.

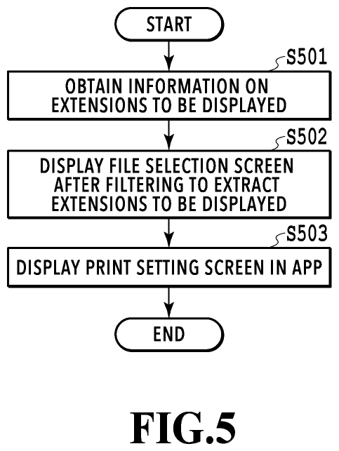

FIG. 5 is a flowchart presenting an example of a sequence of processing in the photo print function in the portal app 201. The processing presented in the flowchart of FIG. 5 is implemented by the CPU 111 reading out the program of the portal app stored in the ROM 112, the external storage device 114, or the like into the RAM 113 and executing it. Some or all of functions in steps of FIG. 5 may be implemented by hardware such as an ASIC or electronic circuit. Sign “S” in description of each process indicates a step in this flowchart. The same applies to processing in the flowchart to be described below in the present specification. A process in each of various steps is a process actually executed by the CPU 111 functioning as the portal app 201, but for the sake of simplicity, the process will be explained assuming that the portal app 201 is an entity to execute the process. In addition, similarly, processing or the like executed by the OS 202 is also processing actually executed by the CPU 111 functioning as the OS 202, but for the sake of simplicity, the processing will be explained assuming that the OS 202 is an entity to execute the processing. The same applies to processing executed by the filer 206 and the data editor app 203.

The processing in FIG. 5 is started at timing at which the portal app 201 receives an instruction to execute the photo print function, the instruction made by the user pressing down the photo print function button 403.

In S501, the portal app 201 obtains information on extensions to be displayed. For example, the portal app 201 obtains, from a storage area used by the portal app 201, an extension list for filtering to extract files to be displayed on a file selection screen.

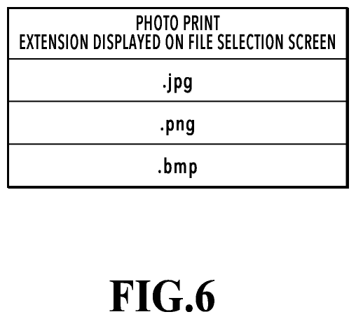

FIG. 6 is a diagram presenting a list of extensions to be displayed on the file selection screen for the photo print function (referred to as an extension list compatible with the photo print function). The extension list presented in FIG. 6 is stored in the storage area used by the portal app 201 in the external storage device 114 or the like. As presented in FIG. 6, the extension list obtained in S501 stores “.jpg”, “.png”, and “.bmp”. These extensions are of files in data formats that can be processed (interpreted) by the portal app 201.

In S502, the portal app 201 performs a process of displaying the file selection screen after filtering to extract the extensions to be displayed. For example, the portal app 201 notifies the OS 202 of the extensions contained in the extension list obtained in S501, and instructs the OS 202 to display the file selection screen. Upon receipt of the instruction to display the file selection screen, the OS 202 displays the file selection screen based on the notified information on the extension list on the display unit 119 by using the filer function. In other words, the file selection screen is displayed by the filer 206. This process performs control so that the file selection screen displays files with the extensions contained in the extension list obtained in S501 among files held in the host computer 101. Moreover, the process performs the control so that the file selection screen hides (does not display) files with extensions other than the extensions contained in the extension list obtained in S501 among the files held in the host computer 101.

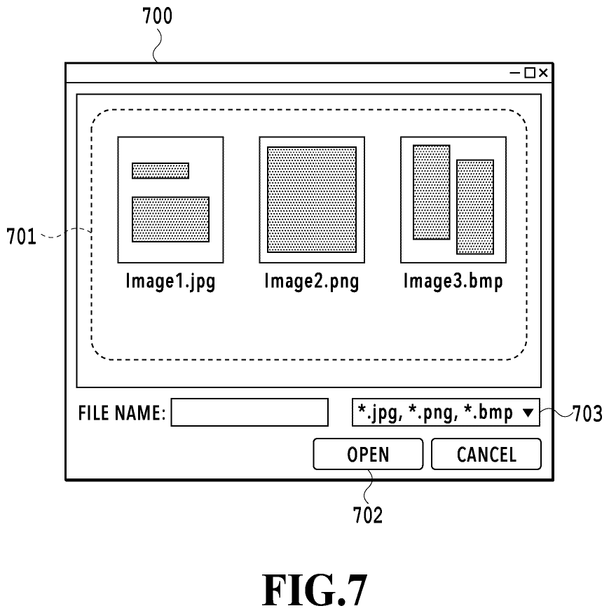

FIG. 7 is a diagram illustrating an example of a file selection screen 700 displayed in the photo print function by the OS 202. FIG. 7 is an example of a screen displayed by the OS 202 using the filer function. A file selection area 701 in FIG. 7 is an area for displaying a list of files stored in the external storage device 114 or the like. As described above, regarding files displayed in the file selection area 701, only files with the extensions contained in the extension list which the OS 202 is notified of in S502 are displayed and files with the extensions not contained in the extension list are hidden. In short, in this example, only files with the “.jpg” “.png”, and “.bmp” extensions are displayed in the file selection area 701.

Although the example in which the extensions contained in the extension list obtained in S501 by the portal app 201 are “.jpg”, “.png”, and “.bmp” is described in the present embodiment, the extension list may contain other extensions. In this case, files with the other extensions are also displayed in the file selection area 701.

In addition, the files displayed in the file selection area 701 by the portal app 201 may be files other than those stored in the external storage device 114. For example, files stored in an external server (not illustrated) may be displayed.

A filter extension selection control 703 is a control for the user to select extensions of files to be displayed in the file selection area 701. The filter extension selection control 703 allows a selection from only the extensions contained in the extension list which the OS 202 is notified of in S502. Specifically, in this example, only the extensions “.jpg”, “.png”, and “.bmp” are selectable. In other words, the filter extension selection control 703 does not perform control to allow “all” extensions to be selected, but performs the control to allow only specific extensions to be selected. For example, in a case where the user selects the “.jpg” extension in the filter extension selection control 703, only files with the “.jpg” extension are displayed in the file selection area 701.

Although the example in which the portal app 201 displays the file selection screen 700 by using the filer function in the OS 202 (that is, causes the filer 206 to display the file selection screen 700) in S502 is described in the present embodiment, another mode may be employed. In another possible mode, for example, the portal app 201 obtains a file list stored in the external storage device 114 via the OS 202. Then, the portal app 201 generates the file selection screen and displays the obtained file list on the generated file selection screen. In this case, the portal app 201 controls file display on the file selection screen to be displayed so that the file selection screen displays only files with the extensions contained in the extension list obtained in S501.

The user can designate a file desired to be printed by selecting the file in the file selection area 701 and pressing down an open button 702. Upon receipt of the selection and designation of the file from the user, the portal app 201 identifies which file is selected and designated, and advances the processing to S503. In the mode in which the filer 206 displays the file selection screen 700, the filer 206 notifies the portal app 201 of which file is selected by the user on the file selection screen 700. According this notification, the portal app 201 identifies which file is selected and designated.

In S503, the portal app 201 displays an app's print setting screen. Specifically, the portal app 201 displays the print setting screen for displaying a print image of the file selected by the user. In the present embodiment, it is assumed that all the extensions contained in the extension list compatible with the photo print function are extensions processable in the portal app 201. In other words, in the present embodiment, it is assumed that there is not any chance to execute, in response to a selection of a file on the file selection screen in the photo print function, a process of launching an external app and causing the external app to open the file. However, the embodiment is not limited to this mode. For example, the extension list compatible with the photo print function may contain an extension other than the extensions processable in the portal app 201. In a case where a file with such extension is selected on the file selection screen in the photo print function, the process of launching an external app or causing the external app to open the file may be executed.

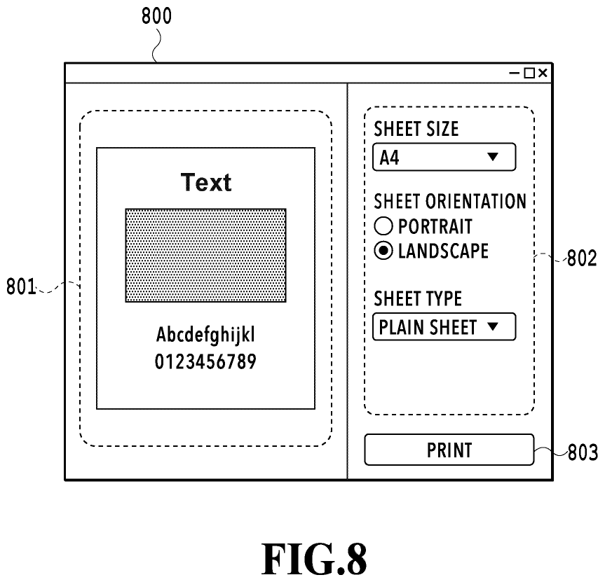

FIG. 8 is a diagram illustrating an example of a print setting screen 800 displayed by the portal app 201. The print setting screen 800 contains a preview area 801 and a print setting area 802. In order to display the print setting screen 800, the portal app 201 generates a preview screen of the file designated by the user by rendering. In addition, the portal app 201 obtains the print settings from the printer driver 204 dedicated to the target printer device 102 and reflects the print settings in the print setting area 802. The user can check the print image of the selected file by checking the preview area 801. Moreover, the user can change any of the print settings to a desired set value by operating the print setting area 802. The portal app 201 may update the print image in the preview area 801 according to the changed print settings. In a case where the user presses down a print button 803, the portal app 201 starts a print process of the file selected by the user under the current print settings, and transmits a print job to the printer driver 204. The above describes the operation overview of the portal app 201 in the photo print function.

Next, an operation overview of the portal app 201 in the document print function will be described. Upon receipt of an instruction by the user pressing down the document print function button 404, the portal app 201 starts executing the document print function.

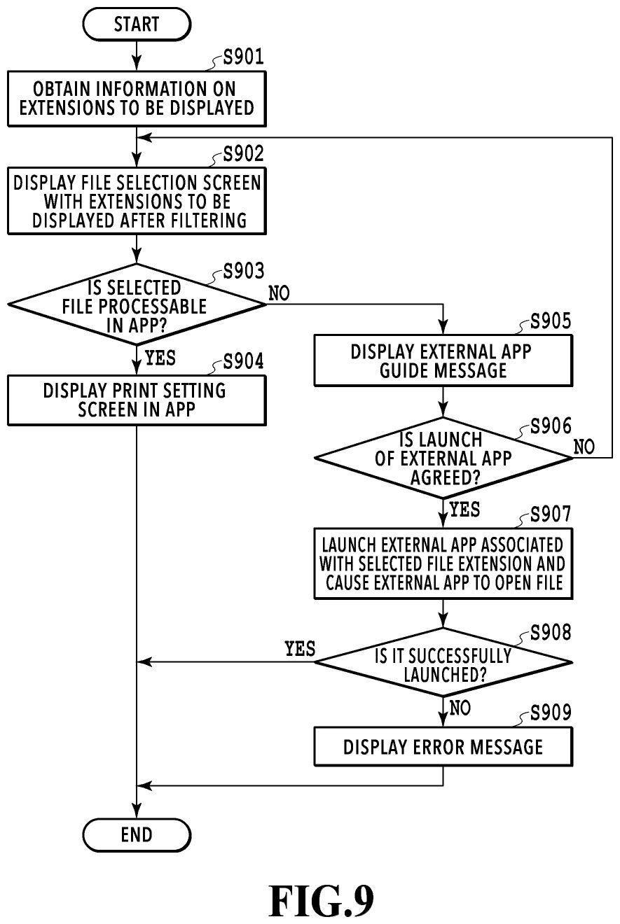

FIG. 9 is a flowchart presenting an example of a sequence of processing in the document print function in the portal app 201. The processing in FIG. 9 is started at timing at which the portal app 201 receives an instruction to execute the document print function, the instruction made by the user pressing down the document print function button 404.

In S901, the portal app 201 obtains, from the storage area used by the portal app 201, an extension list for filtering to extract files to be displayed on a file selection screen.

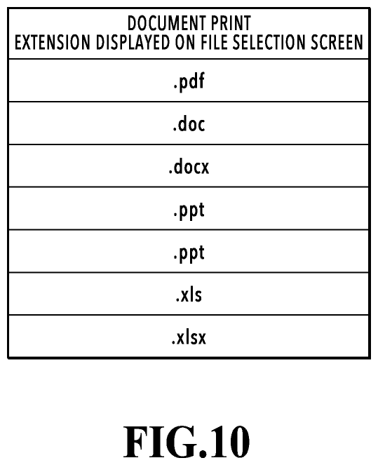

FIG. 10 is a diagram presenting a list of extensions to be displayed on the file selection screen for the document print function (referred to as an extension list compatible with the document print function). The extension list presented in FIG. 10 is stored in the storage area used by the portal app 201 in the external storage device 114 or the like. The extension list obtained in S901 is assumed to be the list presented in FIG. 10. The list in FIG. 10 stores “.pdf”, “.doc”, “.docx”, “.ppt”, “.pptx”, “.xls”, and “.xlsx”. In the present embodiment, the extensions contained in the extension list compatible with the document print function are different from the extensions contained in the extension list compatible with the photo print function.

In the present embodiment, it is assumed that the portal app 201 is capable of interpreting and processing a file with the extension “.pdf”, but is incapable of interpreting and professing files with the other extensions “.doc”, “.docx”, “.ppt”, “.pptx”, “.xls”, and “.xlsx”. In other words, in the present embodiment, the portal app 201 is configured to display, on the file selection screen, also files in data formats that cannot be interpreted and processed in the portal app 201 by itself.

In S902, the portal app 201 performs a process of displaying the file selection screen after filtering to extract the extensions to be displayed. For example, the portal app 201 notifies the OS 202 of the extensions contained in the extension list obtained in S901, and instructs the OS 202 to display the file selection screen. Upon receipt of the instruction to display the file selection screen, the OS 202 displays the file selection screen based on the notified information on the extension list on the display unit 119 by using the filer function. In other words, the file selection screen is displayed by the filer 206. This process performs control so that the file selection screen displays files with the extensions contained in the extension list obtained in S901 among files held in the host computer 101. On the other hand, this process performs the control so that the file selection screen hides files with extensions other than the extensions contained in the extension list obtained in S901 among the files held in the host computer 101.

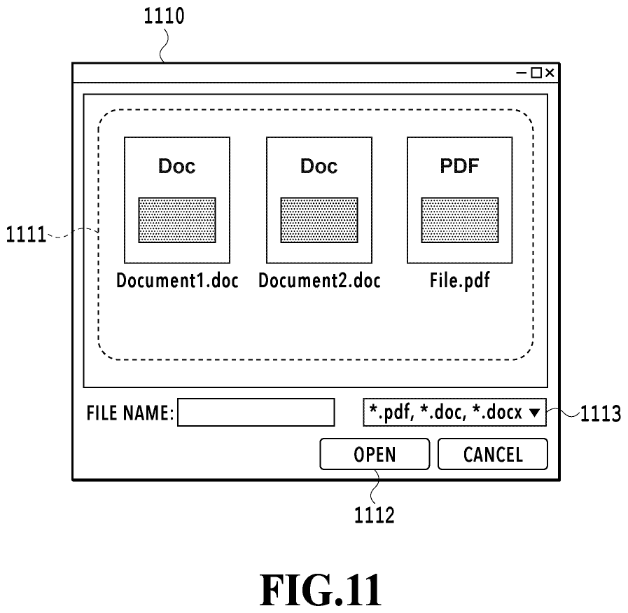

FIG. 11 is a diagram illustrating an example of a file selection screen 1110 displayed in the document print function by the OS 202. A file selection area 1111 in FIG. 11 is an area where a list of files stored in the external storage device 114 or the like is displayed. As described above, regarding files displayed in the file selection screen 1110, only files with the extensions, which are contained in the extension list and which the OS 202 is notified of in S902, are displayed and files with the extensions not contained in the extension list are hidden. In this example, only files with the “.pdf”, “.doc”, “.docx”, “.ppt”, “.pptx”, “.xls”, and “.xlsx” extensions are displayed in the file selection area 1111. Here, the extensions contained in the extension list obtained in S901 by the portal app 201 may include other extensions. In addition, the files displayed on the file selection area 1111 by the portal app 201 may be files other than those stored in the external storage device 114. For example, files stored in an external server (not illustrated) may be displayed.

A filter extension selection control 1113 is a control for the user to select extensions of files to be displayed in the file selection area 1111. In the filter extension selection control 1113, only the extensions, which are contained in the extension list and which the OS 202 is notified of in S902, are selectable. Specifically, in this example, only the extensions “.pdf”, “.doc”, “.docx”, “.ppt”, “.pptx”, “.xls”, and “.xlsx” are selectable. In other words, the filter extension selection control 1113 does not perform control to allow “all” extensions to be selected, but performs the control to allow only specific extensions to be selected. For example, in a case where the user selects the “.pdf” extension in the filter extension selection control 1113, only files with the “.pdf” extension are displayed in the file selection area 1111. As described above, the portal app 201 is configured such that even files in data formats that cannot be processed (interpreted) by the portal app 201 by itself are not filtered out but are displayed on the file selection screen as long as the files have the extensions contained in the extension list obtained in S901.

This example is described in the mode where the portal app 201 displays the file selection screen 1110 by using the filer function of the OS 202 (that is, causes the filer 206 to display the file selection screen 1110) in S902. However, another mode may be employed in which the portal app 201 generates and displays the file selection screen as in the case of the example described regarding the photo print function.

The user can designate a file desired to be printed by selecting the file in the file selection area 1111 and pressing down an open button 1112. Upon receipt of the selection and designation of the file from the user, the portal app 201 identifies which file is selected and designated, and advances the processing to S903. In the mode in which the filer 206 displays the file selection screen 700, the filer 206 notifies the portal app 201 of which file is selected by the user on the file selection screen 700. According to this notification, the portal app 201 identifies which file is selected and designated.

In S903, the portal app 201 determines whether or not the file selected in the file selection area 1111 has an extension processable in the portal app 201. If determining that the file selected in the file selection area 1111 has an extension processable in the portal app 201, the CPU 111 proceeds to S904. If determining that the file selected in the file selection area 1111 has an extension unprocessable in the portal app 201, the CPU 111 proceeds to S905. In the case where the CPU 111 proceeds to S904, a process of launching an external app (a process in S907 to be described later) is not executed. The determination method in S903 is, for example, a method in which the portal app 201 holds a list of extensions processable in the portal app 201 in a storage area of the portal app 201, and makes the above determination based on whether or not the extension of the selected file is any of the extensions in the extension list. Whether or not to launch an external app is controlled based on a result of this determination as will be described later, so in other words, this determination is a determination on whether or not to launch an external app. In the mode described above, what is specifically determined in this process is whether or not the file selected in the file selection area 1111 has an extension processable in the portal app 201, but the determination is not limited to this mode. For example, what is specifically determined in this process may be whether or not the file selected in the file selection area 1111 has an extension excluded from print targets for the photo print function in the portal app 201. In other words, for example, even in a case where the file selected in the file selection area 1111 has an extension processable in the portal app 201 in a function other than the photo print function, NO may be determined in this process.

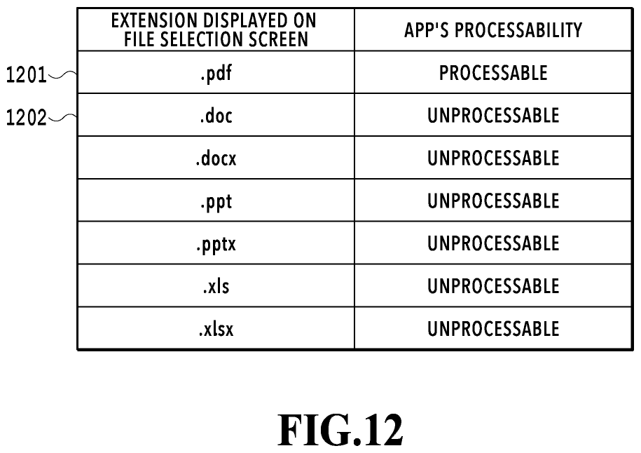

FIG. 12 is an example of a list for use in the determination in S903, in which list extensions to be displayed on the file selection screen and information on whether each of the extensions is processable in the app are stored. As described above, a file with the “.pdf” extension is set to be processable in the portal app 201. On the other hand, files with the “.doc”, “.docx”, “.ppt”, “.pptx”, “.xls”, and “.xlsx” extensions are set to be unprocessable in the portal app 201 (or extensions unprocessable/unprintable in the photo print function of the portal app 201). This list is stored in the storage area of the app. The list presented in FIG. 12 may be stored alone as in this example, or may be stored as an additional item in the list of extensions to be displayed on the file selection screen as illustrated in FIG. 10.

For example, the user is assumed to select a file with the “.pdf” extension on the file selection screen. In this case, the portal app 201 refers to an item 1201 in the list of FIG. 12, determines that the selected file is processable in the portal app 201, and advances the processing to S904.

In S904, the portal app 201 displays a print setting screen for displaying a print image of the file selected by the user. The configuration of the print setting screen is the same as the print setting screen for the photo print function described with reference to FIG. 8, so the description thereof is omitted herein. In a case where the user presses down the print button 803 in FIG. 8, the portal app 201 starts the print process of the file selected by the user, and transmits a print job to the printer driver 204.

In this way, the portal app 201 is configured to display the print preview and perform the print process in the portal app 201 in a case where a file with a processable file extension is selected.

On the other hand, the user is assumed to select a file with the “.doc” extension on the file selection screen displayed in S902. In this case, the portal app 201 refers to an item 1202 in the list of FIG. 12, determines that the selected file is unprocessable in the portal app 201, and advances the processing to S905.

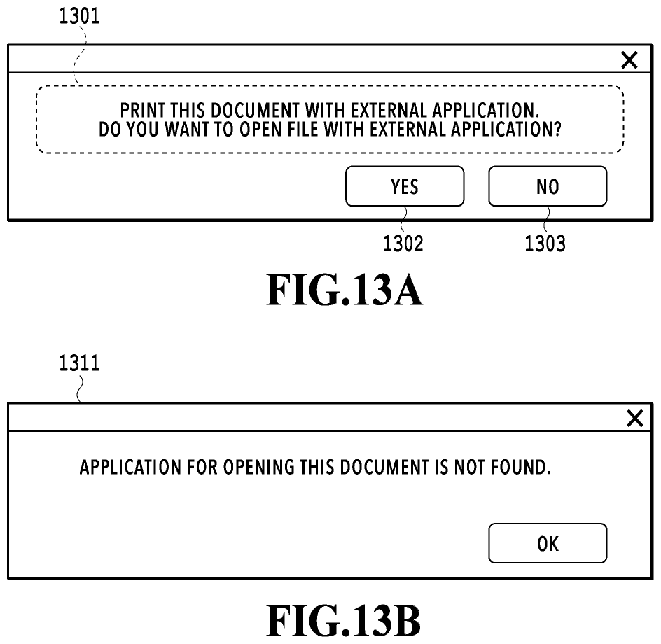

In S905, the portal app 201 displays an external app guide message. FIGS. 13A and 13B are diagrams illustrating an example of messages displayed by the portal app 201. FIG. 13A presents a display example of an external app guide message. As the external app guide message, a guide message 1301 asking whether or not to open the selected file with an external app, an agree button 1302, and a disagree button 1303 are displayed. In a case where the portal app 201 receives a user's operation of pressing down any of the agree button 1302 and the disagree button 1303, the portal app 201 advances the processing to S906. In other words, the message displayed herein is a message for notifying the user that the file selected by the user is a file unprintable by the portal app 201. To put it differently, the message displayed herein is a message for promoting the user to open the file selected by the user with the external app in order to print the file.

In S906, the portal app 201 determines whether or not the user agrees to open the file with the external app. In other words, the portal app 201 determines whether or not the user presses down the agree button 1302. If detecting the user pressing down the agree button 1302, the portal app 201 advances the processing to S907. On the other hand, if detecting the user pressing down the disagree button 1303, the portal app 201 returns the processing to S902, and again displays the file selection screen.

In the present embodiment, the portal app 201 is configured to perform filtering for the file selection screen as described above. Then, the portal app 201 displays some of files unprocessable (incompatible files) in the portal app 201 on the file selection screen in a selectable manner. In a case where the user selects any of the incompatible files, the portal app 201 displays the external app guide message. As a result, the user can understand that the file selected by the user is unprintable by the portal app 201 and needs to be printed by the external app. In the present embodiment, the portal app 201 is configured to confirm whether or not to open the file with the external app by displaying the external app guide message to prompt the user to press down either of the agree button 1302 and the disagree button 1303. Thus, in a case where the user does not desire to launch the external app, the user can cancel the processing. However, the processing is not limited to this mode and may be in a mode in which display of the external app guide message is skipped. In this mode, for example, after NO is determined in S903, the processes in S905 and S906 are skipped and the process in S907 is immediately executed.

In S907, the portal app 201 performs a process of launching the external app associated with the extension of the selected file, and causing the external app to open the file. For example, the portal app 201 launches the external app associated with the file extension via the OS 202. More specifically, the portal app 201 transmits, to the OS 202, an instruction to open the selected file with the application (program) associated with the file extension of the file. According to this instruction, the OS 202 identifies the application associated with the file extension by referring to the file extension association data 205 in FIG. 3. The OS 202 launches the identified application, and causes the launched application to open the selected file. In this way, the OS 202 is the entity to execute the process of opening an external app, but the portal app 201 transmits the instruction to the OS 202. This means that the portal app 201 performs a control process of launching an external app associated with the extension of the selected file and causing the external app to open the file. In the present embodiment, the external app is assumed to have a function (print function) to print a file opened by the external app. In the print function, for example, the external app activates the printer driver and passes the file opened by the external app to the printer driver. The printer driver after receiving the file generates print data for printing the file, and transmits the print data to the printer device. As a result, the file opened by the external app is printed. Therefore, after the file is opened by the external app, the user can print the file by executing an operation on the external app for executing the print function of the external app.

In a case where the user selects a file with the “.doc” extension in S902 by way of an example, the OS 202 refers to the item 302 in the file extension association data 205 in FIG. 3. After that, the OS 202 launches the document editor app associated with the “.doc” extension and causes the document editor app to open the file selected by the user. Then, the user can print the file with the “.doc” extension by using the print function of the launched document editor app. Also in a case where the user selects any of files with extensions unprocessable in the app other than the “.doc” extension in S902, an external app associated with the file extension is launched in the same manner and the user can print the file with the extension by using the external app.

In the present embodiment, files with the extensions unprocessable in the portal app 201 (or excluded from processing/printing targets in the photo print function of the portal app 201) are also displayed on the file selection screen in a selectable manner. Then, even in a case where a file with a file extension unprocessable in the portal app 201 is selected on the file selection screen, the portal app 201 performs the control to cause the external app associated with the extension to open the file. As a result, the user can print the file via the external app. In other words, from the document print function button 404 of the portal app 201, even a file unprocessable in the portal app 201 can be led to printing in the same way as for files processable in the portal app 201. Therefore, in the present embodiment, since the routes leading to printing are unified into one route, the user does not have to switch an app to be launched first depending on a file extension. That is, the user is allowed to print various files through the one route via the portal app 201, which improves the user's convenience.

Even in the mode where the portal app 201 generates the file selection screen, the portal app 201 performs the process of causing the OS 202 to launch the external app associated with the selected file extension and open the file with the external app.

The description returns to the flowchart in FIG. 9. After the process in S907 is completed, the portal app 201 proceeds to a process in S908.

In S908, the portal app 201 obtains, from the OS 202, a determination as to whether or not the external app is successfully launched in S907. In the case where the external app is successfully launched, the portal app 201 ends the processing in the flowchart of FIG. 9. In the case where the external app fails to be launched, the portal app 201 advances the processing to S909.

Whether or not the OS 202 succeeds in launching the application in S907 is determined herein based on whether or not information about the application associated with the extension of the file selected in S902 is stored in the file extension association data 205. In a case where the information about the application associated with the extension of the file selected in S902 is stored in the file extension association data 205, the OS 202 succeeds in launching the application in S907. On the other hand, in a case where the information about the application associated with the extension of the file selected in S902 is not stored in the file extension association data 205, the OS 202 fails to launch the application in S907. An example of the case where information about an application associated with an extension of a file is not stored in the file extension association data 205 is a case where the application associated with the extension of the file is not installed in the host computer 101.

In S909, the portal app 201 displays an error message to notify that the an application for opening the file is not found. An message 1311 in FIG. 13B is a diagram illustrating an example of an error message given by the portal app 201 for notifying that the application fails to be launched. Such display of the error message in the case where the application associated with the file extension is not found enables the user to understand that the application associated with the file selected by the user is unavailable. After the error message is displayed in S909, the portal app 201 ends the processing in the flowchart of FIG. 9.

According to the present embodiment, it is possible to further improve the convenience of an application such as the portal app 201 as described above. Specifically, according to the present embodiment, the user can easily understand that a file selected by the user is in a file format unprocessable in the portal app. In addition, the user is allowed to launch an external application associated with a file via the portal app 201 and cause even a file incompatible with the portal app 201 to be seamlessly printed via the external application. Thus, the print process of even a file unprocessable in the portal app can be started from the portal app in the same way as for files processable in the portal app, so that the routes leading to printing are unified into one route, thereby improving user's convenience.

### Other Embodiments

In the above embodiment, the example is described in which, even among files unprocessable in the document print function by the portal app 201, specific types of files are displayed on the file selection screen. Then, the example is described in which the processes of displaying the external app guide message and launching the external app to open the file are performed in the document print function. However, these processes may be performed in another function. For example, the photo print function may be configured to also perform the processes as described in the document print function. These processes may be performed in any one or both of the document print function and the photo print function.

In the foregoing embodiment, the example is described in which in the case where the selected file is unprocessable in the portal app 201, the portal app 201 displays the external app guide message and causes the external app to be launched if the user agrees to launch the external app. Instead, a mode in which display of the external app guide message is skipped may be employed. Specifically, in a case where the selected file is unprocessable in the portal app 201, the portal app 201 may perform control to launch the associated app without asking the user for confirmation. Even in this mode, it is possible to produce the effect of unifying the routes leading to printing into one route by using the portal app 201, thereby improving the usability.

On the other hand, in another mode, in the case where the selected file is unprocessable in the portal app 201, the portal app 201 may only display the external app guide message without performing the control to launch the external app. In this case, as the external app guide message, a message to prompt the user to launch the external app and open the file is displayed. Even in this mode, the user can recognize that the file is in the file format unprocessable in the portal app 201, so that the usability can be improved.

Thus, the usability can be improved with the portal app 201 performing only one of the display of the external app guide message and the launch of the external app. However, it is more preferable that the portal app 201 perform both of the display of the external app guide message and the launch of the external app as described in the above embodiment, because the usability can be further improved.

In addition, although the example in which only one file is selected on the file selection screen is described in the above embodiment, two or more files may be selected on the file selection screen. In this case, if at least one of the selected files is in a file format unprocessable in the portal app 201, the portal app 201 may display the external app guide message or launch the external app. On the other hand, for the files in the formats processable in the portal app 201, the portal app 201 may display the print setting screen as described above. In other words, the portal app 201 may perform the display of the print setting screen and the launch of the external app concurrently.

In addition, although the example in which a certain process performed by the portal app 201 includes the print process and related processes is described in the above embodiment, the certain process is not limited to this example. For example, the certain process may be an editing process or a data transmission process.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-044642, filed Mar. 21, 2024, which is hereby incorporated by reference wherein in its entirety.

What is claimed is:

1. A method of controlling an information processing apparatus including a first application program, comprising:
notifying an operating system (OS) in the information processing apparatus of one or more extensions;
executing control to display a selection screen for selecting data; and
in a case where an extension of data selected on the selection screen is contained in the one or more extensions which the OS is notified of and is contained in one or more extensions compatible with a print function equipped in the first application program, executing a first process of causing the first application program to display a screen for executing printing based on the data selected on the selection screen, and
in a case where the extension of the data selected on the selection screen is contained in the one or more extensions which the OS is notified of but is not contained in the one or more extensions compatible with the print function, executing a second process of launching a second application program which is different from the first application program and which supports the extension of the data selected on the selection screen.

2. The control method according to claim 1, wherein the control to display the selection screen is control to cause a third application program to display the selection screen, the third application program being different from the first application program and different from the second application program.

3. The control method according to claim 2, further comprising causing the first application program to receive a notification of information on data selected on the selection screen displayed by the third application program.

4. The control method according to claim 1, wherein, in a case where the OS is notified of the one or more extensions compatible with the print function, the selection screen is controlled so as to display data having any of the one or more extensions compatible with the print function and hide data not having any of the one or more extensions compatible with the print function.

5. The control method according to claim 1, further comprising executing a determination process of determining whether or not the extension of the data selected on the selection screen is an extension contained in the one or more extensions compatible with the print function, wherein
the first process is executed based on a result of the determination process indicating that the extension of the data selected on the selection screen is an extension contained in the one or more extensions compatible with the print function, and
the second process is executed based on a result of the determination process indicating that the extension of the data selected on the selection screen is an extension not contained in the one or more extensions compatible with the print function.

6. The control method according to claim 1, wherein the first process includes a process of displaying a print setting screen for printing based on the data selected on the selection screen.

7. The control method according to claim 1, wherein the first process includes a process of displaying a preview screen for printing based on the data selected on the selection screen.

8. The control method according to claim 1, wherein
the first process includes a process of displaying a screen for asking a user whether or not to launch the second application program,
the second application program is launched in a case where an operation for launching the second application program is performed on the screen being displayed, and
the second application program is not launched in a case where an operation for cancelling the launch of the second application program is performed on the screen being displayed.

9. The control method according to claim 1, wherein the first process includes a process of displaying a message indicating that the printing based on the data selected on the selection screen is not executable by the second application program.

10. The control method according to claim 1, further comprising executing a process of displaying a message indicating that the second application program is not installed in the information processing apparatus in a case where the extension of the data selected on the selection screen is contained in the one or more extensions which the OS is notified of and is contained in the one or more extensions compatible with the print function, and in a case where the second application program is not installed in the information processing apparatus.

11. The control method according to claim 1, wherein
the first application program has a plurality of print functions including a first print function and a second print function, and
the one or more extensions compatible with the first print function are different from the one or more extensions compatible with the second print function.

12. The control method according to claim 11, wherein
in a case where an operation for executing the first print function is performed, the OS is notified of the one or more extensions compatible with the first print function and the one or more extensions incompatible with the first print function, and
in a case where an operation for executing the second print function is performed, the OS is notified of the one or more extensions compatible with the second print function but is not notified of the one or more extensions incompatible with the second print function.

13. The control method according to claim 12, wherein
the one or more extensions compatible with the first print function include at least an extension in a pdf format, and
the one or more extensions compatible with the second print function include at least one of an extension in a Jpeg format, an extension in a png format, and an extension in a bmp format.

14. The control method according to claim 12, wherein the one or more extensions incompatible with the first print function include at least one of an extension in a doc format, an extension in a docx format, an extension in a ppt format, an extension in an xls format, and an extension in an xlsx format.

15. The control method according to claim 12, wherein
the first print function is a document print function, and
the second print function is a photo print function.

16. The control method according to claim 1, wherein the second process includes a process of instructing the OS to open the data selected on the selection screen by using the second application program.

17. The control method according to claim 16, wherein the second application program has a function to print the data opened by the second application program.

18. The control method according to claim 1, further comprising transmitting a print job to a printer device after the first process is executed, the print job being for the printer device to execute the printing based on the data selected on the selection screen.

19. A non-transitory computer readable storage medium storing a first application program causing a computer of an information processing apparatus to execute:
notifying an operating system (OS) in the information processing apparatus of one or more extensions;
executing control to display a selection screen for selecting data; and
in a case where an extension of data selected on the selection screen is contained in the one or more extensions which the OS is notified of and is contained in one or more extensions compatible with a print function equipped in the first application program, executing a first process of causing the first application program to display a screen for executing printing based on the data selected on the selection screen, and
in a case where the extension of the data selected on the selection screen is contained in the one or more extensions which the OS is notified of but is not contained in the one or more extensions compatible with the print function, executing a second process of launching a second application program which is different from the first application program and which supports the extension of the data selected on the selection screen.

20. An information processing apparatus including a first application program, comprising:
a notification unit configured to notify an operating system (OS) in the information processing apparatus of one or more extensions;
a control unit configured to execute control to display a selection screen for selecting data; and
an execution unit configured to execute a first process in a case where an extension of data selected on the selection screen is contained in the one or more extensions which the OS is notified of and is contained in one or more extensions compatible with a print function equipped in the first application program, the first processing including causing the first application program to display a screen for executing printing based on the data selected on the selection screen, and to execute a second process in a case where the extension of the data selected on the selection screen is contained in the one or more extensions which the OS is notified of but is not contained in one or more extensions compatible with the print function, the second process including launching a second application program which is different from the first application program and which supports the extension of the data selected on the selection screen.
